(19) United States
(12) Patent Application Publication
(10) Pub. No.: US 2018/0376549 A1
(43) Pub. Date: Dec. 27, 2018

(54) LED BACKLIGHT DRIVER AND LCD

(71) Applicant: Shenzhen China Star Optoelectronics Technology Co., Ltd., Shenzhen, Guangdong (CN)

(72) Inventor: Wendong LI, Shenzhen, Guangdong (CN)

(73) Assignee: Shenzhen China Star Optoelectronics Technology Co., Ltd., Shenzhen, Guangdong (CN)

(21) Appl. No.: 15/535,445

(22) PCT Filed: Jan. 16, 2017
(86) PCT No.: PCT/CN2017/071298

§ 371 Date: Jun. 13, 2017

(30) Foreign Application Priority Data
Jan. 4, 2017 (CN) 201710004105.8

(51) Int. Cl. H05B 33/08; G09G 3/34

(52) U.S. Cl. CPC H05B 33/083; G09G 3/3406; H05B 33/0884

(57) ABSTRACT

A light emitting diode (LED) backlight driver includes a power supply, an LED string having LEDs, a protection circuit, and a driver chip. A positive terminal of the LED string is electrically connected to the power supply. One terminal of the protection circuit is electrically connected to a negative terminal of the LED string. A first pin of the driver chip is electrically connected to the other terminal of the protection circuit. When the LED string works normally, the protection circuit is conducted. Once two terminals of the LED in the LED string are short-circuited, the protection circuit is automatically disconnected to protect the driver chip. An LCD using the LED backlight driver is provided. By using the present disclosure, pin damage of a driver chip does not occur.

### CROSS REFERENCE TO RELATED APPLICATION

This application claims priority to Chinese Application No. 201710004105.8, filed Jan. 4, 2017. The entire disclosures of each of the above applications are incorporated herein by reference.

### FIELD OF THE INVENTION

The present disclosure relates to the technical field of liquid crystal display, and more particularly, to a light emitting diode (LED) and a liquid crystal display (LCD).

### BACKGROUND OF THE INVENTION

As the display technology advances, a backlight technique for a liquid crystal display (LCD) continues developing. A conventional LCD backlight source adopts a cold cathode fluorescent lamp (CCFL). Because the CCFL backlight source is disadvantageous of poor color recovery, low lighting efficiency, high discharge voltage, poor discharge under low temperature, and long time for heating until stable grayscale, an LED (light emitting diode) backlight technology has been developed for the conventional backlight source technique.

Please refer to FIG. 1 illustrating a conventional light emitting diode (LED) backlight driver. The LED backlight driver includes a power supply, an LED string, and a driver chip. In particular, a positive terminal of the LED string is electrically connected to the power supply. A negative terminal of the LED string is electrically connected to a pin of the driver chip. The driver chip is used to drive the LED string.

In the course of using the LED backlight driver, sometimes one terminal (such as positive terminal) of the LED and the other terminal (such as negative terminal) of the LED are short-circuited in the process of using the LCD (the two terminals of the last LED are short-circuited as shown in FIG. 1), which causes the voltage applied on the pin of the LED string electrically connected to the driver chip to increase. However, the pin is a low-voltage pin. Once the voltage applied on the pin is greater than the voltage-resistance of the pin, the pin of the driver chip will be broken and the driver chip is damaged. Even worse, sparks may fly out, which will bring danger to the system security.

The related art proposes two schemes. One of the schemes is to arrange a high-voltage-resistant transistor in a pin of a driver chip. The process of this scheme is complicated, which increases the production costs of the driver chip. The other scheme is to arrange a low-voltage-resistant transistor in a pin of a driver chip. The production costs for this scheme is comparatively lower; however, the pin of the driver chip is easily broken and damaged once the voltage is greater than the voltage-resistance of the transistor. Both of the schemes are not to the industry's satisfaction.

### SUMMARY OF THE INVENTION

An object of the present disclosure is to propose a light emitting diode (LED) backlight driver and a liquid crystal display (LCD) to reduce the possibility of pin damage of a driver chip.

In a first aspect of the present disclosure, a light emitting diode (LED) backlight driver includes: a power supply; an LED string, comprising a plurality of LEDs; a positive terminal of the LED string electrically connected to the power supply; a protection circuit, one terminal of the protection circuit electrically connected to a negative terminal of the LED string; a driver chip, a first pin of the driver chip electrically connected to the other terminal of the protection circuit. When the LED string works normally, the protection circuit is conducted; once two terminals of the LED in the LED string are short-circuited, the protection circuit is automatically disconnected to protect the driver chip.

According to an embodiment of the present disclosure, the LED string comprises a first LED string. The first LED string comprises a plurality of LEDs connected in series; a positive terminal of the first LED string is electrically connected to the power supply. The protection circuit comprises a first protection circuit; one terminal of the first protection circuit is electrically connected to a negative terminal of the first LED string. The other terminal of the first protection circuit is electrically connected to the first pin of the driver chip. When the first LED string works normally, the first protection circuit is conducted; once two terminals of the second LED in the first LED string are short-circuited, the first protection circuit is automatically disconnected to protect the driver chip.

According to an embodiment of the present disclosure, the first protection circuit comprises: a first protection power supply circuit; a first transistor, a drain of the first transistor electrically connected to the negative terminal of the first LED string; a source of the first transistor electrically connected to the first pin of the driver chip; a gate of the first transistor electrically connected to the first protection power supply circuit; the first protection power supply circuit driving the first transistor to conduct.

According to an embodiment of the present disclosure, the first protection power supply circuit comprises: a first protection power supply; a first resistor, a first terminal of the first resistor electrically connected to the first protection power supply; a second terminal of the first resistor electrically connected to the gate of the first transistor; a second resistor, a first terminal of the second resistor electrically connected to the second terminal of the first resistor; a second terminal of the second resistor electrically connected to the source of the first transistor.

According to an embodiment of the present disclosure, the first protection power supply circuit further comprises: a first diode, an anode of the first diode electrically connected to the source of the first transistor; a cathode of the first diode electrically connected to the gate of the first transistor.

According to an embodiment of the present disclosure, a resistance of the first resistor is less than a resistance of the second resistor.

According to an embodiment of the present disclosure, voltage-resistance of the first transistor is greater than or equal to 50 volts (50V).

According to an embodiment of the present disclosure, the LED string further comprises a second LED string; the second LED string comprises a plurality of LEDs connected in series; the first LED string and the second LED string are connected in parallel. A positive terminal of the second LED string is electrically connected to the power supply. The protection circuit further comprises a second protection circuit. One terminal of the second protection circuit is electrically connected to a negative terminal of the second LED string; the other terminal of the second protection circuit is electrically connected to a second pin of the driver chip; when the second LED string works normally, the second protection circuit is conducted; once two terminals of the second LED in the second LED string are short-circuited, the second protection circuit is automatically disconnected to protect the driver chip.

According to an embodiment of the present disclosure, a second transistor is arranged in the driver chip; voltage-resistance of the second transistor is less than or equal to 10V; a drain of the second transistor is connected to the first pin of the driver chip; a source of the second transistor is grounded; a gate of the second transistor is connected to a control unit in the driver chip.

In a first aspect of the present disclosure, a liquid crystal display (LCD) comprises a liquid crystal panel and a backlight module. The liquid crystal panel and the backlight module are arranged opposite. The backlight module supplying a light source to the liquid crystal panel for the liquid crystal panel to show an image; the backlight module adopting a light emitting diode (LED) backlight source; the LED backlight source adopting an LED backlight driver as provided above.

Implementation of the present disclosure brings benefits as follows:

The LED backlight driver includes a protection circuit. When the LED string works normally owing to the protection circuit, the protection circuit is conducted. Once two terminals of the LED in the LED string are short-circuited, the protection circuit is automatically disconnected to protect the driver chip. In this way, pin damage of a driver chip does not occur, which helps reduce the destruction of the driver chip.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a circuit diagram of a conventional light emitting diode (LED) backlight driver.

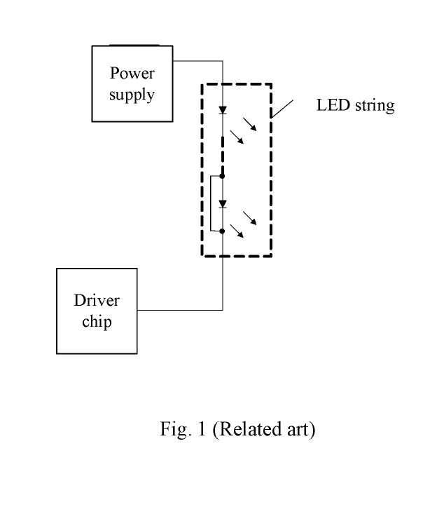

FIG. 2 illustrates a circuit diagram of a light emitting diode (LED) backlight driver according to a first embodiment of the present disclosure.

FIG. 3 illustrates short-circuited LEDs of the LED backlight driver as illustrated in FIG. 2.

FIG. 4 is a circuit diagram of a light emitting diode (LED) backlight driver according to a second embodiment of the present disclosure.

### REFERENCE SIGN

110—Power supply; 120—first LED string; 130—Driver chip; Q2—Second transistor; 200—First protection circuit; 210—First protection power supply circuit; 211—First protection power supply; R1—First resistor; R2—Second resistor; D1—First diode; Q1—First transistor; 320—Second LED series; 400—Second protection circuit; 410—Second protection power supply circuit; 411—Second protection power supply; R3—Third resistor; R4—Fourth resistor; D2—Second diode; Q3—Third transistor.

### DETAILED DESCRIPTION OF THE PREFERRED EMBODIMENTS

For the purpose of description rather than limitation, the following provides such specific details as a specific system structure, interface, and technology for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details.

The terminology used herein is for the purpose of describing particular embodiments only and is not intended to be limiting of the invention. As used herein, the terms “comprise” and “include” are defined as to have as parts or members, unless the context clearly indicates otherwise. For example, a process, method, system, product or device having a series of steps or units, may optionally have other steps or units not listed or optionally have inherent steps or units. It will be understood that the term “first,” “second,” and “third” when used in this specification, specify various associated elements, rather than a specific order.

### Embodiment 1

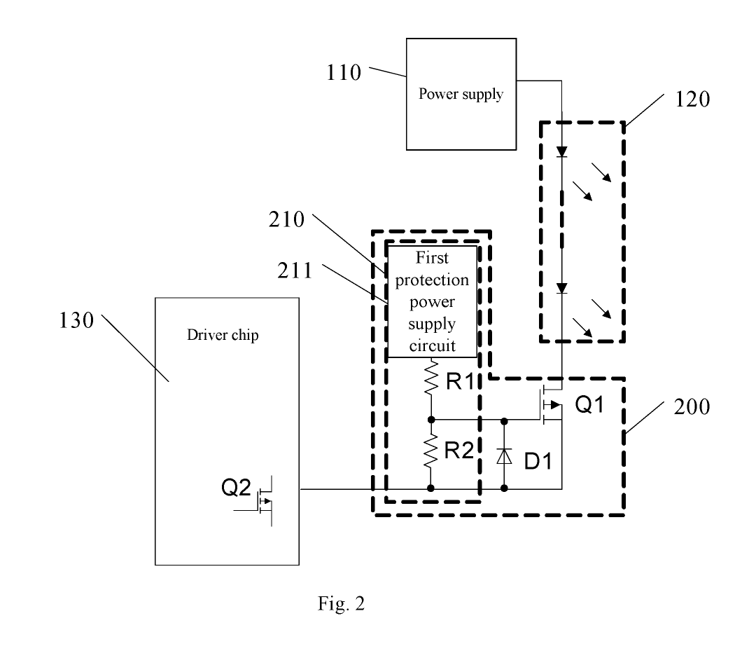

Please refer to FIG. 2 illustrating a light emitting diode (LED) backlight driver according to a first embodiment of the present disclosure. The LED backlight driver includes a power supply 110, an LED string, a protection circuit, and a driver chip 130.

In particular, the power supply 110 is used to supply power to the LED string. The power supply 110 is, for example, a direct current (DC) power supply output by other supply circuits or a direct current power supply output by a power manager. The power supply 110 supplies an output voltage such as 36 volts (V), 48V, 60V, or 72V with which the LED string is driven.

The LED string includes a plurality of LEDs. A positive terminal of the LED string is electrically connected to the power supply 110. The number of LEDs for the LED string can be determined on demand, for example, 2, 4, 6, 8, 9, or 10 LEDs. The LEDs for the LED string can be connected in parallel or in series.

One terminal of the protection circuit is electrically connected to a negative terminal of the LED string. The protection circuit is used to prevent the driver chip 130 from being damaged once two terminals of the LED are short-circuited.

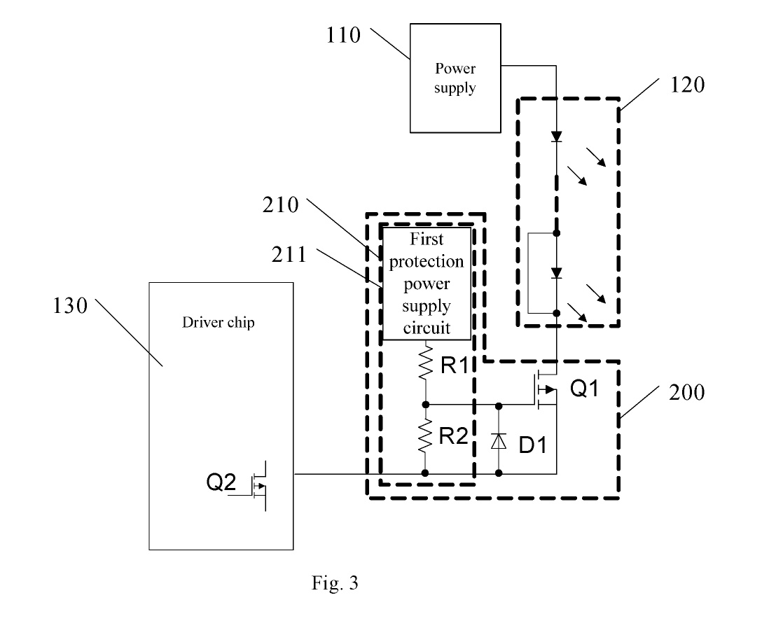

The first pin of the driver chip 130 is electrically connected to the other terminal of the protection circuit. When the LED string works normally (for example, LED string supplies a light source normally) and the LED string is not short-circuited, the protection circuit is conducted and works normally, and stress applied on the first pin which the negative terminal of the LED string is electrically connected to is normal (as FIG. 3 shows). Or, when a plus (+) terminal of a previous LED and a minus (−) terminal of a following LED are short-circuited, the current in the LED string will enlarge and the voltage applied on the negative terminal of the LED string will increase otherwise. To prevent the enlarged voltage from being applied on the first pin of the driver chip 130, the protection circuit is automatically disconnected. In this way, the negative terminal of the LED string is disconnected from the first pin of the driver chip 130 electrically, which helps reduce the possibility of damaging the first pin of the driver chip 130 and prevent the driver chip 130 from being damaged.

When the LED string works normally owing to the protection circuit, the protection circuit is conducted. Once two terminals of the second LED in the second LED string are short-circuited, the protection circuit is automatically disconnected to protect the driver chip 130. In this way, the first pin of the driver chip 130 will not be damaged, which means that the possibility of occurrence of a damaged driver chip 130 is less.

The LED string includes a first LED string 120. The first LED string 120 includes a plurality of LEDs in series in this embodiment. The LEDs in the first LED string 120 are connected in parallel and in series. A positive terminal of the first LED string 120 is electrically connected to the power supply 110. The protection circuit includes a first protection circuit 200. One terminal of the first protection circuit 200 is electrically connected to a negative terminal of the first LED string 120. The other terminal of the first protection circuit 200 is electrically connected to the first pin of the driver chip 130. When the first LED string 120 works normally, the first protection circuit 200 is conducted. Once two terminals of the second LED in the first LED string 120 are short-circuited, the first protection circuit 200 is automatically disconnected to protect the driver chip 130.

The first protection circuit 200 includes a first protection power supply circuit 210 and a first transistor Q1. A drain of the first transistor Q1 is electrically connected to a negative terminal of the first LED string 120. A source of the first transistor Q1 is electrically connected to the first pin of the driver chip 130. A gate of the first transistor Q1 is electrically connected to the first protection power supply circuit 210 so that the first protection power supply circuit 210 can control conduction and termination of the first protection power supply circuit 210. The first protection power supply circuit 210 drives the first transistor Q1 to conduct and keeps conducted. The first protection power supply circuit 210 may supply the gate of the first transistor Q1 with a voltage such as 15V, 14V, 13V, 12V, 11V, 10V, 9V, 8V and so on in this embodiment.

The first protection power supply circuit 210 includes a first protection power supply 211, a first resistor R1, and a second resistor R2 in this embodiment. The first protection power supply 211 is used to supply power. The first protection power supply 211 may be a direct current power supply output by other supply circuits or a direct current power supply output by a power manager. The first protection power supply 211 supplies an output voltage such as 15V, 12V, 10V, 9V, etc. A first terminal of the first resistor R1 is electrically connected to the first protection power supply 211. A second terminal of the first resistor R1 is electrically connected to the gate of the first transistor Q1. A first terminal of the second resistor R2 is electrically connected to the second terminal of the first resistor R1. A second terminal of the second resistor R2 is electrically connected to the source of the first transistor Q1. The first resistor R1 and the second resistor R2 are used to share voltage to ensure that the Vgs voltage applied on the first transistor Q1 is greater than the threshold voltage to make the first transistor Q1 keep conducted. The resistance of the first resistor R1 is less than the resistance of the second resistor R2. For example, the resistance of the first resistor R1 is 30 k ohm, 20 k ohm, 10 k ohm, 5 k ohm, and 1 k ohm; and the resistance of the second resistor R2 is 300 k ohm, 200 k ohm, 100 k ohm, 50 k ohm, and 10 k ohm. The ratio coverage of the resistance of the first resistor R1 and the resistance of the second resistor R2 is 1:50-1:5, such as 1:50, 1:40, 1:30, 1:20, 1:10, 1:9, 1:8, 1:7, 1:6, 1:5, preferably 1:10. The first protection circuit 200 further includes a first diode D1. An anode of the first diode D1 is electrically connected to the source of the first transistor Q1, and a cathode of the first diode D1 is electrically connected to the gate of the first transistor Q1. The first diode D1 is used to stabilize voltage. In addition, the first protection circuit may not include a first diode in other embodiments. In addition, the first protection power supply circuit may be other kinds of circuits known by a person who is skilled in the relevant field of technology or a direct current power supply.

When the first LED string 120 works normally, the first transistor Q1 is conducted. The first LED string 120 is electrically connected to the first pin of the driver chip 130 through the source of the first transistor Q1. When two terminals of the LED in the first LED string 120 are short-circuited, for example, the positive (+) terminal and negative terminal (−) of the same LED short-circuited (referring to FIG. 3) or a previous LED and a minus (−) terminal of a following LED short-circuited, the resistor of the first LED string 120 will decrease, which causes the current in the first LED string 120 to enlarge and the voltage applied on the negative terminal of the first LED string 120 to increase or sharply increase. In other words, the voltage applied on the drain of the first transistor Q1 will sharply increase, and the voltage applied on the source of the first transistor Q1 will rise rapidly. When the voltage applied on the source of the first transistor Q1 rises to a certain level, the Vgs voltage applied on the first transistor Q1 (voltage between the gate and the source) is less than a threshold voltage, and the conducted first transistor Q1 is turned off. In this way, the voltage is applied on the negative terminal of the first LED string 120 will not be sent to the first pin of the driver chip 130, which prevents the first pin of the driver chip 130 from being broken. In other words, the first pin of the driver chip 130 and the driver chip 130 are both protected.

To prevent the first transistor Q1 from being broken, the first transistor Q1 is a high-voltage-resistant transistor, and the voltage-resistance of the first transistor Q1 is greater than or equal to 50 volts (50V) such as 50V, 60V, 70V, 80V, 90V, 100V, etc. in this embodiment. The first transistor Q1 will not be broken within this range. The first transistor Q1 is an N-Channel MOSFET (NMOS) transistor. Of course, a person who is skilled in the relevant field of technology could know that the first transistor Q1 may be a switch component, which functions like the NMOS transistor in other embodiments.

A second transistor Q2 is arranged in the driver chip 130. The second transistor Q2 is a low-voltage transistor. The voltage-resistance of the second transistor Q2 is less than or equal to 10V such as 10V, 9V, 8V, 7V, 6V, 5V, etc., which costs lower. The second transistor Q2 is used to control conduction and disconnection of the first LED string 120 to turn up and off the LED in the first LED string 120. In particular, the drain of the second transistor Q2 is connected to the first pin of the driver chip 130; that is, the drain of the second transistor Q2 is connected to a source of the first transistor Q1, and a source of the second transistor Q2 is grounded. The gate of the second transistor Q2 is electrically connected to a control unit in the driver chip 130 to control conduction and disconnection of the second transistor Q2 to turn up or turn off the first LED string 120. The second transistor Q2 is arranged in the driver chip 130, which helps save space and costs.

### Embodiment 2

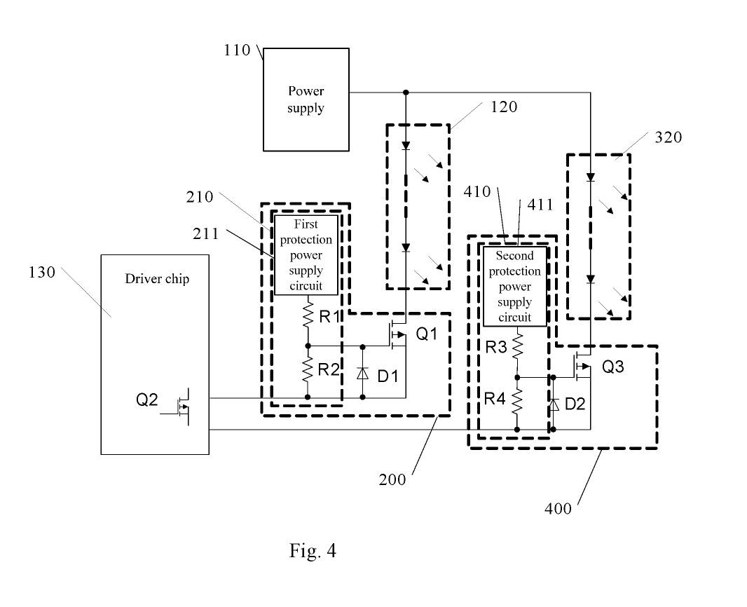

FIG. 4 is a light emitting diode (LED) backlight driver according to a second embodiment of the present disclosure. The circuit in FIG. 4 is similar to the circuit in FIG. 2. If a label in FIG. 4 is consistent with any one of the labels in FIG. 2, it means that components with the same labels are used in this embodiment. The main differences between the second embodiment and the first embodiment are the light emitting diode (LED) string and the protection circuit.

Please refer to FIG. 4. The LED string further includes a second LED string 320. The second LED string 320 includes a plurality of LED connected in series. The first LED string 320 and the second LED string 320 are connected in parallel. A positive terminal of the second LED string 320 is electrically connected to a power supply 110. The protection circuit further includes a second protection circuit 400. One terminal of the second protection circuit 400 is electrically connected to a negative terminal of the second LED string 320. The other terminal of the second protection circuit 400 is electrically connected to a second pin of the driver chip 130. When the second LED string 320 works normally, the second protection circuit 400 is conducted. Once two terminals of the second LED in the second LED string 320 are short-circuited, the second protection circuit 400 is automatically disconnected to protect the driver chip 130.

The second protection circuit 400 includes a second protection power supply circuit 410 and a third transistor Q3. A drain of the third transistor Q3 is electrically connected to the negative terminal of the second LED string 320. A source of the third transistor Q3 is electrically connected to the second pin of a driver chip 130. A gate of the third transistor Q3 is electrically connected to the second protection power supply circuit 410 so that the second protection power supply circuit 410 can control conduction and termination of the third transistor Q3. The second protection power supply circuit 410 drives the third transistor Q3 to conduct and keeps conducted. The first protection power supply circuit 210 may supply the gate of the third transistor Q3 with a voltage such as 15V, 14V, 13V, 12V, 11V, 10V, 9V, 8V and so on in this embodiment.

The second protection power supply circuit 410 includes a second protection power supply 411, a third resistor R3, and a fourth resistor R4. The second protection power supply 411 is used to supply power in this embodiment. The second protection power supply 411 may be a direct current power supply output by other supply circuits or a direct current power supply output by a power manager. The second protection power supply 411 supplies an output voltage such as 15V, 12V, 10V, 9V, etc. A first terminal of the third transistor Q3 is electrically connected to the second protection power supply 411. A second terminal of the third transistor Q3 is electrically connected to the gate of the third transistor Q3. A first terminal of the fourth resistor R4 is electrically connected to the second terminal of the third resistor R3. A second terminal of the fourth resistor R4 is electrically connected to the source of the third transistor Q3. The third resistor R3 and the fourth resistor R4 are used to share voltage to ensure that the Vgs voltage applied on the third transistor Q3 is greater than the threshold voltage to make the third transistor Q3 keep conducted. The resistance of the first resistor R1 is less than the resistance of the second resistor R2 in this embodiment. The ratio of the resistance of the first resistor R1 and the resistance of the second resistor R2 is 1:50-1:5, preferably 1:10. The second protection circuit 400 further includes a second diode D2. An anode of the second diode D2 is electrically connected to the source the third transistor Q3, and a cathode of the second diode D2 is electrically connected to the gate of the third transistor Q3. The second diode D2 is used to stabilize voltage. In addition, the second protection circuit may not include a second diode in other embodiments.

When the second LED string 320 works normally, the third transistor Q3 is conducted. The second LED string 120 is electrically connected to the second pin of the driver chip 130 through the source of the third transistor Q3. When two terminals of the LED in the second LED string 320 are short-circuited, the voltage applied on the negative terminal of the second LED string 320 will increase. In other words, the voltage applied on the negative terminal the voltage applied on the drain of the third transistor Q3 will sharply increase, and the voltage applied on the source of the third transistor Q3 will rise rapidly. When the voltage applied on the source of the third transistor Q3 rises to a certain level, the Vgs voltage applied on the third transistor Q3 (voltage between the gate and the source) is less than a threshold voltage, and the conducted third transistor Q3 is turned off. In this way, the voltage is applied on the negative terminal of the second LED string 320 will not be sent to the second pin of the driver chip 130, which prevents the second pin of the driver chip 130 from being broken. In other words, the second pin of the driver chip 130 and the driver chip 130 are both protected. The present embodiment can also be applied for a variety of conditions, for example, when a plurality of LEDs is needed.

It is notified that each of the embodiments in the specifications is progressive in descriptions. Each of the embodiments has its highlight different from the others. The similar descriptions in these embodiments may be referred to. A device embodiment is basically similar to a method embodiment while is simpler in descriptions. If the device embodiment is relevant to the method embodiment, the relevance can be referred to directly.

Implementation of the present disclosure brings benefits as follows:

The LED backlight driver includes a protection circuit. When the LED string works normally owing to the protection circuit, the protection circuit is conducted. Once two terminals of the LED in the LED string are short-circuited, the protection circuit is automatically disconnected to protect the driver chip. In this way, pin damage of a driver chip does not occur, which helps reduce the destruction of the driver chip.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

1. A light emitting diode (LED) backlight driver, comprising:
a power supply;
an LED string, comprising a plurality of LEDs; a positive terminal of the LED string electrically connected to the power supply;
a protection circuit, one terminal of the protection circuit electrically connected to a negative terminal of the LED string;
a driver chip, a first pin of the driver chip electrically connected to the other terminal of the protection circuit wherein when the LED string works normally, the protection circuit is conducted; once two terminals of the LED in the LED string are short-circuited, the protection circuit is automatically disconnected to protect the driver chip.

2. The LED backlight driver of claim 1, wherein the LED string comprises a first LED string; the first LED string comprises a plurality of LEDs connected in series; a positive terminal of the first LED string is electrically connected to the power supply; the protection circuit comprises a first protection circuit; one terminal of the first protection circuit is electrically connected to a negative terminal of the first LED string; the other terminal of the first protection circuit is electrically connected to the first pin of the driver chip; when the first LED string works normally, the first protection circuit is conducted; once two terminals of the second LED in the first LED string are short-circuited, the first protection circuit is automatically disconnected to protect the driver chip.

3. The LED backlight driver of claim 2, wherein the first protection circuit comprises:
a first protection power supply circuit;
a first transistor, a drain of the first transistor electrically connected to the negative terminal of the first LED string; a source of the first transistor electrically connected to the first pin of the driver chip; a gate of the first transistor electrically connected to the first protection power supply circuit; the first protection power supply circuit driving the first transistor to conduct.

4. The LED backlight driver of claim 3, wherein the first protection power supply circuit comprises:
a first protection power supply;
a first resistor, a first terminal of the first resistor electrically connected to the first protection power supply; a second terminal of the first resistor electrically connected to the gate of the first transistor;
a second resistor, a first terminal of the second resistor electrically connected to the second terminal of the first resistor; a second terminal of the second resistor electrically connected to the source of the first transistor.

5. The LED backlight driver of claim 4, wherein the first protection power supply circuit further comprises:
a first diode, an anode of the first diode electrically connected to the source of the first transistor; a cathode of the first diode electrically connected to the gate of the first transistor.

6. The LED backlight driver of claim 4, wherein a resistance of the first resistor is less than a resistance of the second resistor.

7. The LED backlight driver of claim 3, wherein
voltage-resistance of the first transistor is greater than or equal to 50 volts (50V).

8. The LED backlight driver of claim 2, wherein the LED string further comprises a second LED string; the second LED string comprises a plurality of LEDs connected in series; the first LED string and the second LED string are connected in parallel; a positive terminal of the second LED string is electrically connected to the power supply; the protection circuit further comprises a second protection circuit; one terminal of the second protection circuit is electrically connected to a negative terminal of the second LED string; the other terminal of the second protection circuit is electrically connected to a second pin of the driver chip; when the second LED string works normally, the second protection circuit is conducted; once two terminals of the second LED in the second LED string are short-circuited, the second protection circuit is automatically disconnected to protect the driver chip.

9. The LED backlight driver of claim 1, wherein a second transistor is arranged in the driver chip; voltage-resistance of the second transistor is less than or equal to 10V; a drain of the second transistor is connected to the first pin of the driver chip; a source of the second transistor is grounded; a gate of the second transistor is connected to a control unit in the driver chip.

10. A liquid crystal display (LCD), comprising: a liquid crystal panel and a backlight module; the liquid crystal panel and the backlight module being arranged opposite; the backlight module supplying a light source to the liquid crystal panel for the liquid crystal panel to show an image; the backlight module adopting a light emitting diode (LED) backlight source; the LED backlight source adopting an LED backlight driver of claim 1.
